(19) United States
(12) Patent Application Publication
(10) Pub. No.: US 2023/0060758 A1
(43) Pub. Date: Mar. 2, 2023

(54) Orchestration of Activities of Entities Operating in a Network Cloud

(71) Applicant: DRIVENETS LTD., Raanana (IL)

(72) Inventors: Eli FEDIDA, Avtalion (IL); Amir KRAYDEN, Hertzelia (IL); Gal ZOLKOVER, Haifa (IL)

(21) Appl. No.: 17/929,149

(22) Filed: Sep. 1, 2022

Related U.S. Application Data
(63) Continuation-in-part of application No. 17/312,665, filed on Jun. 10, 2021.
(60) Provisional application No. 62/778,897, filed on Dec. 13, 2018.

(51) Int. Cl. H04L 41/5009; H04L 41/0816

(52) U.S. Cl. CPC H04L 41/5009; H04L 41/0816

(57) ABSTRACT

A method and a communication system configured to operate in a network cloud, are provided. The system comprising a plurality of physical network elements and a server comprising a database storing a plurality of pre-defined actions and a plurality of thresholds values associated with key performance indicators (KPIs); wherein the server is configured to operate as a cloud orchestrator and to receive from the plurality of physical network elements information that relates to key performance indicators (KPIs); wherein upon determining that an action that relates to one or more specific physical network elements from among the plurality of physical network elements needs to be executed, wherein the determination is based on a) the information received from the plurality of physical network elements, and b) one or more threshold stored values and associated with said KPIs, an action selected from among the stored plurality of pre-defined actions is initiated, and required details associated with said selected pre-defined action are retrieved; and wherein the cloud orchestrator is further configured to receive new KPIs from said one or more specific physical network elements and to verify that an improvement has occurred in their operation.

### TECHNICAL FIELD

The present disclosure relates generally to the field of networking, and in particular, to the management of a plurality of forwarding network nodes such as routers and switches in a network cloud.

### Glossary

AI—Artificial Intelligence
ACL—Access Control List
BW—Bandwidth
BOM—Bill Of Materials
DDOS—Distributed Denial of Service
KPI—Key Performance Indicators
NC—Network Cloud
NCC—Network Cloud Controller
NCF—Network Cloud Fabric
NCM—Network Cloud Management
NCP—Network Cloud Packet Forwarder
NOS—Network Operating System.
NCC—Network Cloud Controller
NE—Network Element
NS—Network Switch
ODM—Original Design Manufacturer
VRF—virtual routing and forwarding
VPN—Virtual Private Network
SDN—Software Defined Network
NFV—Network Functions Virtualization
VNF—Virtual Network Function

### BACKGROUND

The term Network Cloud (NC) refers to a cloud that is being used for serving network functionalities such as routing, switching, etc. In other words, it refers to a concept of disaggregating network entities hardware and software. The control plan of a network entity is decoupled from its data-path, and is installed on a local server or in a network cloud. An underlying abstraction layer separates the control element and makes it agnostic to the data-path related hardware components. The data-path runs on a distributed hardware resources such as servers, network interfaces and white box devices and may be programmed directly.

Network cloud concept uses cloud methodology to serve Software Defined Network (“SDN”) services such as routing, switching, VPN, QOS, DDOS mitigation and the like in a more efficient, centrally controlled and easily programmable way.

The separation that nowadays exists between software and hardware in the networking field, has resulted in a new model of a network cloud, wherein an optimized usage of hardware resources is implemented to enable deploying of a distributed network operating system.

Nowadays, network operators are facing a financial problem as the network elements' prices are relatively high per device and consequently the price is high on a “per port” basis, whereas the income per subscriber remains mostly constant and, in some cases, has even declined. Obviously, this affects the profitability of network owners and encourages them to look for ways to implement a cost reduction approach. Many network operators and large network owners, such as web-scale owners, have adopted the approach of implementing white-boxes in their networks, where a white-box is a hardware element that is manufactured by silicon ODMs (commodity chipsets sellers). This approach allows network operators to use different white boxes manufactured by different manufacturers, within the same distributed network cloud cluster and thereby to reduce the hardware price to a model of BOM cost plus an agreed-upon margin. Yet, this approach is rather different from the traditional approach, whereby network elements were purchased as a monolithic device of hardware and software combined together. As was mentioned above, the hardware part of the problem (i.e. the hardware part of the network elements) was solved by adopting the white-box approach. Still, the adoption of this approach has created new challenges for the software part of the problem. Since this approach involves multiple software modules and containers, the use of distributed hardware nodes solution which comprises a plurality of hardware white-boxes, requires the software modules and containers to run in synchronization.

When this concept is adopted, different functionalities may be distributed between hardware resources as they can function along the data-path while allowing packet processing. Alternatively, they can function as fabric entities allowing communication between data-path elements, or as network controllers handling routing protocols or while carrying out any other applicable functionality.

Enterprises, as well as communication service providers, who implement a virtualized network cloud, are facing new challenges that relate to the installation, deployment, configuration, orchestration, provisioning and monitoring of the plurality of different entities required in the lifecycle management of the cluster, whether these entities are network cloud routers, switches or any other applicable network element.

Additionally, as the complexity of the distributed network cloud increases, there is an increasing need to enable automatic processes for adding, removing or replacing hardware devices within the network.

Therefore, there is a need for an orchestration model which may be configured for managing a plurality of routing or switching entities in a network cloud. The present invention seeks to fulfill this need.

### SUMMARY

The disclosure may be summarized by referring to the appended claims.

It is an object of the present disclosure to provide a novel solution for managing a plurality of routing and/or switching entities operating in a network cloud.

It is another object of the present disclosure to provide a system, a method and a software program for managing distributed network nodes operating in a network cloud, based on information related to key performance indicators (KPIs) collected from the plurality of physical network elements.

It is another object of the present disclosure to provide a system, a method and a software program for managing distributed network nodes based on threshold values associated with KPIs and the information collected from a plurality of physical network elements.

It is another object of the present disclosure to provide a system, a method and a software program for managing distributed network nodes by pushing information received at a cloud orchestrator of the system to the plurality of different physical network elements thereby enabling achieving a faster response time, as there is no need to exchange communications between the cloud orchestrator and the network elements at the time when an action is required to be affected at the network elements.

Other objects of the present disclosure will become apparent from the following description.

According to a first aspect of the disclosure there is provided a communication system configured to operate in a network cloud, the communication system comprising a plurality of physical network elements each comprising a respective agent and a server comprising a database storing a plurality of pre-defined actions and a plurality of thresholds values associated with key performance indicators (KPIs);

wherein said server is configured to operate as a cloud orchestrator and to receive from said plurality of physical network elements information that relates to key performance indicators (KPIs);

wherein upon determining that an action that relates to one or more specific physical network elements from among the plurality of physical network elements needs to be executed, wherein said determination is based on a) the information received from the plurality of physical network elements, and b) one or more threshold stored values and associated with said KPIs, an action selected from among said stored plurality of pre-defined actions is initiated, and required details associated with said selected pre-defined action are retrieved; and

wherein said cloud orchestrator is further configured to receive new KPIs from said one or more specific physical network elements and to verify that an improvement has occurred in their operation.

The terms “physical network element” or “physical network node” or “hardware network element” or “network element”, as the case may be, are used interchangeably herein throughout the specification and claims to denote a physical entity such as a packet processor, a CPU, a memory, a network interface, and the like, that can act as a single or multiple entities being a part of a virtual routing entity and supports the routing functionality of the latter.

The term “network cloud”, as used herein throughout the specification and claims, refers to a cloud that is being used for serving network functionalities such as routing, switching, etc.

On the other hand, the term “cloud network” denotes network resources (servers, disks, CPUs, and the like) that are used for providing a cloud functionality (e.g., for hosting services, files, sites, and the like), as web scale companies do.

The terms “cloud orchestrator” or “orchestrator” as used herein throughout the specification and claims refer to a cloud management platform that automates provisioning of cloud services using policy-based tools. It enables the user to configure, provision, integrate service management—and add management, monitoring, back-up and security—in a short period of time. The platform comprises a collection of customized individual activities that are specific to a product or technology, so that the activities to be performed thereby are integrated with that product. The cloud orchestrator is typically able of guiding information, providing redundancy, availability, low latency and total transparency among the different communication protocols while offering security, management and capacity to integrate a large number of network elements, and to enable aggregating new members to a network cloud in a fast and secured manner.

According to still another embodiment, the communication system further comprising a cloud controller configured to communicate with the plurality of the physical network elements' agents over a L2/L3 communication channel and to communicate in a two ways communication with the cloud orchestrator.

According to another embodiment, the cloud orchestrator is further configured to trigger a configuration change at at least one of the plurality of physical network elements, in response to determining that one or more threshold values have been exceeded.

By yet another embodiment, the cloud orchestrator is further configured to identify a new device (e.g., a white-box device or another hardware element, server and the likes) when that new device is added to the network cloud, and to associate the new device with a cluster of devices comprised in that network cloud.

According to another embodiment, the cloud orchestrator is operative to configure a hardware device to operate as a network cloud entity by installing one or more software packages and/or software containers at that hardware device, and establishing communications between the hardware device and at least one other network cloud entity, and wherein the one or more software packages and/or software containers installed at the hardware device by the cloud orchestrator, depends on a functionality which will be performed by that network cloud entity when operating as part of the network cloud.

According to still another embodiment, the cloud orchestrator is configured to form a new cluster of physical network elements, and determine one or more of the members included in a group that comprises: type of the new cluster, mandatory and non-mandatory modules to be installed at network elements that are members of the new cluster, a setup for at least one of the mandatory modules and a setup for at least one of the non-mandatory modules, as well as required configurations for physical network elements, and the like.

By yet another embodiment, the cloud orchestrator is operative to configure a communication channel for conveying messages exchanged between physical network elements that are members of a cluster comprising the plurality of physical network elements, and/or between physical network elements that are members of the cluster and the cloud orchestrator. Preferably, these messages comprise at least one type of messages being a member of a group that comprises: keepalive messages, configuration commands forwarded from the cloud orchestrator to modules installed at physical network elements, messages that are sent every pre-determined time interval to the cloud orchestrator and comprise information that relate to at least one of: current telemetry, statistics, events, KPIs, and the like.

According to another embodiment, the cloud orchestrator is configured to add to a cluster a network node that belongs to the network cloud, without interfering with the functionality of that cluster (e.g., without causing a down time to any of the cluster's operative network elements). A network node may be added in any one of the following events:
a. Implementing a new configuration for the cluster's network elements;
b. Identifying a network element (a node) failure and the network element to be added is of the same type and configuration as the failing network element; and
c. Reaching one or more threshold values configured for a set of KPIs, for example: a threshold value may be set to the maximum throughput, when such a threshold value is reached, the cloud orchestrator may add a network node to handle a surplus throughput.

A network node may be shut down in any one of the following events:
a. Implementing a new configuration for the cluster's network elements;
b. Identifying a network element (a node) failure and a network element of the same type and configuration as the failing network element can be used to replace that failing network element; and
c. Reaching one or more threshold values configured for a set of KPIs, for example: a threshold value may be set to the minimum throughput, when that threshold value is reached, the cloud orchestrator will reduce or even shut down, if possible, the resources associated with that element in order to save network cloud's resources.

In accordance with still another embodiment, the cloud orchestrator is configured to ensure that a plurality of physical network elements operate as a single virtual routing entity.

By yet another embodiment, the cloud orchestrator is further configured to forward to the plurality of physical network elements, the plurality of pre-defined actions and the plurality of KPI thresholds values for storage at the plurality of physical network elements, wherein the determination that an action needs to be executed is taken by one or more of the specific physical network elements, and wherein the action is selected from among the plurality of pre-defined actions stored at the one or more of the specific physical network elements and the required details associated with the selected action are retrieved from the one or more of the specific physical network elements' storage.

In accordance with another embodiment, the determination that an action needs to be executed is taken by the cloud orchestrator, and wherein the action is selected from among the plurality of pre-defined actions stored at the said cloud orchestrator database and the required details associated with the selected action are retrieved from the said cloud orchestrator storage.

According to still another embodiment, the cloud orchestrator is further configured to analyze traffic flows that are conveyed via the plurality of physical network elements and to identify traffic trends based on the traffic flows. Preferably, the cloud orchestrator is further configured to determine based on the identified traffic trends one or more automatic actions and their associated threshold values, to be carried out in the communication system.

In accordance with another aspect of the present disclosure there is provided a method for use in a system operating in a network cloud, the system comprising a plurality of physical network elements each comprising a respective agent and a server comprising a database operating as a cloud orchestrator, wherein the method comprises the steps of:

storing a plurality of pre-defined actions and a plurality of thresholds values associated with key performance indicators (KPIs);

receiving information that relates to key performance indicators (KPIs) from said plurality of physical network elements;

determining whether an action that relates to one or more specific physical network elements from among the plurality of physical network elements needs to be executed, wherein the determination is based on a) the information received from the plurality of physical network elements, and b) one or more threshold stored values;

upon determining that an action needs to be executed, retrieving details of the required action from among the plurality of pre-defined stored actions;

retrieving details associated with said selected pre-defined action;

carrying out the required action by the plurality of physical network elements; and

receiving new KPIs from the one or more specific physical network elements and verifying that an improvement has occurred in their operation.

According to another embodiment of this aspect of the disclosure, the method further comprising the steps of determining whether one or more threshold values have been exceeded, and if in the affirmative, triggering a configuration change at at least one of the plurality of physical network elements.

By still another embodiment, the method further comprising a step of establishing a communication channel for conveying messages exchanged between physical network elements that are members of a cluster comprising the plurality of physical network elements, and/or between physical network elements that are members of the cluster and the cloud orchestrator.

According to another embodiment the messages comprise at least one type of messages comprise at least one type of messages being a member of a group that consists of: keepalive messages, configuration commands forwarded from said cloud orchestrator to modules installed at physical network elements, messages that are sent every pre-determined time interval to said cloud orchestrator and comprise information that relate to at least one of: current telemetry, statistics, events and KPIs.

In accordance with another embodiment the method further comprising a step of ensuring that a plurality of physical network elements operate as a single virtual routing entity.

By yet another embodiment, the method further comprising a step of monitoring at least one physical network element and KPIs associated therewith at a pre-defined steady rate, and upon detecting that a malfunction is about to be associated with that physical network element, determining a time period during which relevant KPIs will be sampled at a rate that is higher than the steady rate applied prior to making that determination, thereby enabling to detect the cause for the possible malfunction.

According to another embodiment, the method provided further comprising the steps of:

storing the plurality of pre-defined actions and a plurality of thresholds values associated with key performance indicators (KPIs) at the cloud orchestrator database;

forwarding the plurality of pre-defined actions and a plurality of thresholds values associated with key performance indicators (KPIs) to the plurality of physical network elements and storing them thereat;

determining by one or more of the specific physical network elements whether an action needs to be executed;

upon determining that an action needs to be executed, retrieving details of the required action from among the plurality of pre-defined actions stored at the one or more of the specific physical network elements' storage.

By still another embodiment, the method provided further comprising the steps of:

storing the plurality of pre-defined actions and a plurality of thresholds values associated with key performance indicators (KPIs) at the cloud orchestrator database;

determining by the cloud orchestrator elements whether the action needs to be executed;

upon determining that an action needs to be executed, retrieving details of the required action from among the cloud orchestrator database.

According to yet another aspect of the disclosure there is provided a non-transitory computer readable medium storing a computer program for performing a set of instructions to be executed by one or more computer processors, the computer program is adapted to perform a method for use in a network cloud comprising a plurality of physical network elements and a server configured to operate as a cloud orchestrator, wherein the method comprising the steps of storing a plurality of pre-defined actions and a plurality of thresholds values associated with key performance indicators (KPIs); receiving information that relates to key performance indicators (KPIs) from the plurality of physical network elements; determining whether an action that relates to one or more specific physical network elements from among the plurality of physical network elements needs to be executed, wherein the determination is based on a) the information received from the plurality of physical network elements, and b) one or more threshold stored values; upon determining that said action needs to be executed, retrieving details of the required action from among the plurality of pre-defined stored actions; retrieving details associated with the selected pre-defined action; carrying out the required action by the plurality of physical network elements; and receiving new KPIs from said one or more specific physical network elements and verifying that an improvement has occurred in their operation.

### BRIEF DESCRIPTION OF THE DRAWINGS

The accompanying drawings, which are incorporated herein and constitute a part of this specification, illustrate several embodiments of the disclosure and, together with the description, serve to explain the principles of the embodiments disclosed herein.

FIG. 1. illustrates a network cloud construed in accordance with an embodiment of the present invention;

FIG. 2. demonstrates a schematic block diagram of steps comprised at the stage of configuring a new network element when the latter is added to a network cloud, construed in accordance with an embodiment of the present invention;

FIG. 3. depicts a schematic block diagram comprising steps included at the stage of executing a task by a network element in a network cloud, construed in accordance with an embodiment of the present invention; and

FIG. 4. illustrates a schematic block diagram of steps comprised at the stage of traffic analysis and automatic execution of actions associated with network elements that belong to a network cloud, construed in accordance with an embodiment of the present invention.

### DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods and/or other devices that are known in the art per se. In addition, the described embodiments comprise different steps, not all of which are required in all embodiments of the invention. The scope of the invention can be summarized by referring to the appended claims.

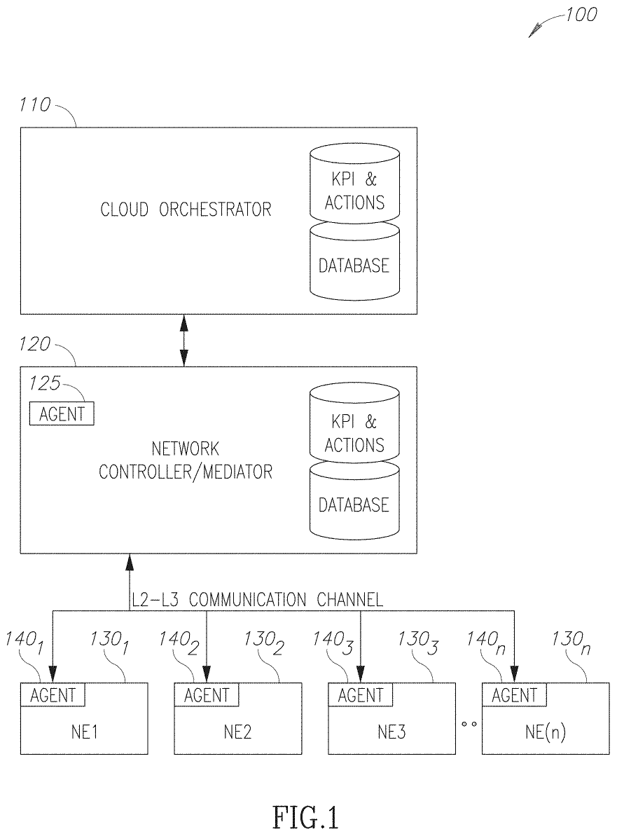

FIG. 1 illustrates a network cloud (100) construed in accordance with an embodiment of the present invention. The network cloud (100) comprises a cloud orchestrator (110) that includes a storage for KPIs and actions and a database being in two-ways communication with cloud controller 120 (e.g. mediator), comprising a storage for KPIs, actions and a database, and wherein network cloud (100) further comprises a plurality of network elements (NEs) 130₁ to 130_{N}, each comprising a respective agent 140₁ to 140_{N}, and wherein these agents are configured to communicate with cloud controller 120 over a L2/L3 communication channel.

A cloud orchestrator automates the management, coordination and organization of complicated computer systems, services and middleware. In addition to a reduced requirement for personnel involvement, the orchestration functionality eliminates the potential errors that might be introduced while carrying out provisioning, scaling or other cloud processes.

Once an operating system (OS) is installed at the cloud orchestrator 110 (and at the network controller 120, if the latter is deployed), agents 140₁ to 140_{N} may be installed at NEs 130₁ to 130_{N} to support communication from cloud orchestrator 110 either directly or through cloud controller 120. Once these agents have been installed, links are established at the L2 layer and respective tunnels may be configured, thereby enabling a two-ways communication between the cloud orchestrator and the network elements.

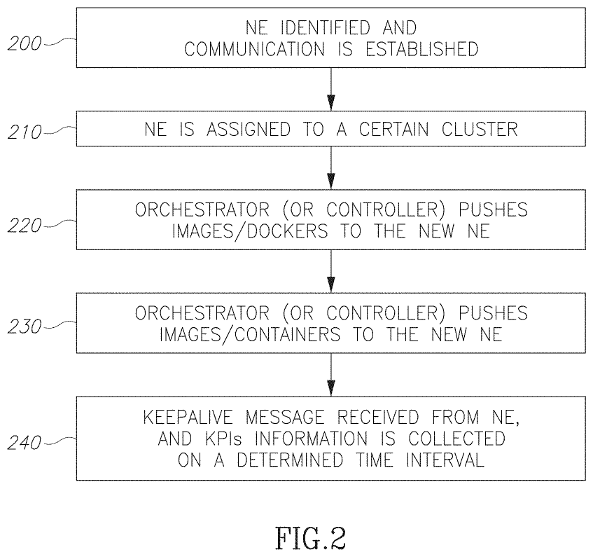

FIGS. 2 to 4 demonstrate various steps included in three different operational stages of a method by which the network cloud referred to hereinabove, operates.

FIG. 2 demonstrates a schematic block diagram of steps comprised at the stage of configuring a new network element when added to a network cloud, construed in accordance with an embodiment of the present invention.

First, the newly added network element, being for example a router or a switch, is identified and a communication link is established between the cloud orchestrator and that new NE (step 200). The NE is then associated by the managing entity with a certain cluster (step 210) and the cloud orchestrator or the cloud controller, as the case may be, forwards images/dockers to the new NE (step 230). Once a keepalive message is sent by the NE to the cloud orchestrator/controller, checking/confirming that the communication link that has been established between the two is operative, a plurality of KPIs will be collected and stored at the cloud orchestrator, preferably at pre-configurable time intervals (step 240).

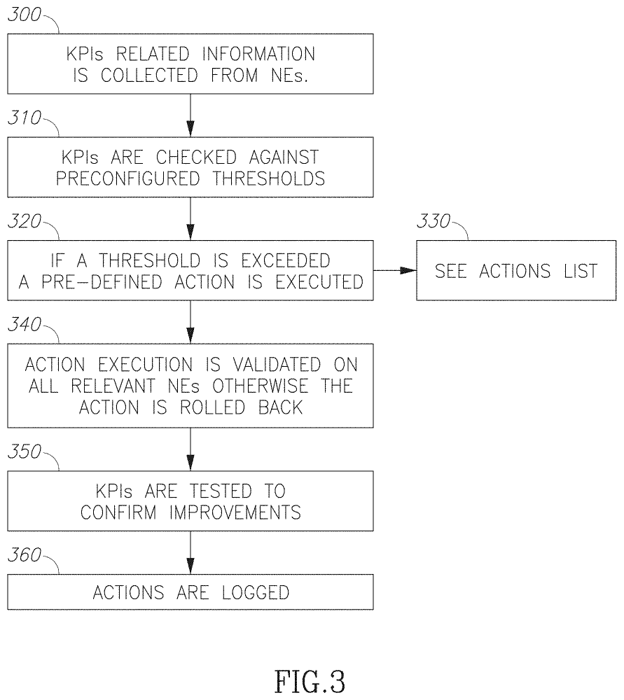

The next stage is exemplified in FIG. 3, which presents a schematic block diagram of steps included at the stage of task execution by the newly added network element. This example comprises the following steps. First, lists of KPIs are collected from the NEs that communicate (directly or indirectly) with the cloud orchestrator (step 300). The KPIs are compared with pre-defined respective threshold values (step 310) and if a certain KPI reaches its respective threshold value, a pre-defined action will be initiated (step 320) after retrieving the required action details from the database located at the cloud orchestrator (step 330). Preferably, once the cloud orchestrator has executed the required action, it confirms by checking with all NEs that are relevant to the action taken, that indeed the action had an effect on these NEs (step 340). Once the confirmation is obtained, the cloud orchestrator receives new KPIs (at least from these relevant NEs) to verify whether an improvement has occurred in their operation (step 350). After verifying that improvements have been achieved at the NEs, the action is logged at the cloud orchestrator storage (step 360).

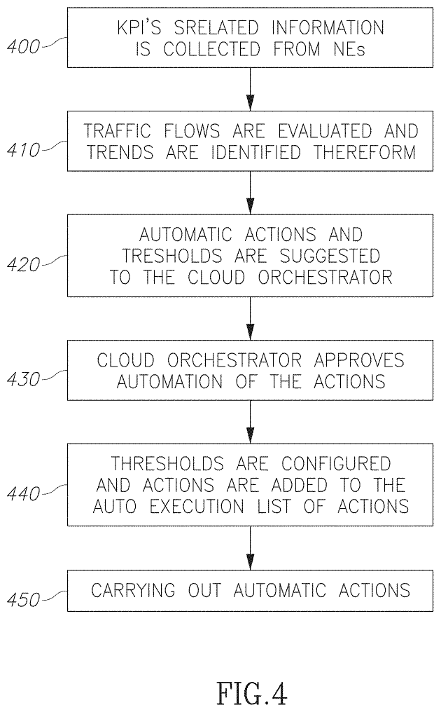

Another phase of the network cloud operation is exemplified in FIG. 4, which illustrates a schematic block diagram of an embodiment of the present disclosure of carrying out traffic analysis and automatic execution of actions associated with network elements that belong to the network cloud.

This phase starts by retrieving KPIs collected from different NEs (step 400). Then, the cloud orchestrator analyzes the traffic flows that are conveyed via these NEs and identifies traffic trends (such as future possible congestion, etc.) based on these traffic flows that were analyzed (step 410). In view of the identified trends, one or more automatic actions and their associated threshold values are suggested to be carried out in the network cloud (step 420), in order to adequately act on the scenarios predicted based on the trends identified in step 410. Once the changes (the new automated actions) are approved (step 430) the new actions and their respective threshold values are added to the cloud orchestrator storage (step 440). Optionally after storing these new actions and their respective threshold values at the cloud orchestrator storage, this information, i.e., the actions and their respective threshold values, are forwarded and stored at at least some of the physical network elements for automatic execution thereof, and upon occurrence of a situation at which the need for a new action arises, the action will be executed automatically (step 450). This embodiment has a number of advantages. First, it enables achieving a faster response time, as it does not require communicating with the cloud orchestrator at the time when an action is actually required to be affected, and second, at times when there is a need to carry out maintenance operations at the cloud orchestrator, real time actions can still be carried out while maintenance operations are carried out at the cloud orchestrator server, independently of the Cloud orchestrator itself, by one or more relevant physical network elements, from among the plurality of the physical network elements comprised in the communication system.

When a configuration change to a network element (e.g., a node) or a plurality of nodes is required, the cloud orchestrator (acting as an administrator) may define a configuration patch (e.g. certain configuration lines or scripts) and set a list of one or more threshold values that will trigger that configuration change. The cloud orchestrator triggers the required configuration change when threshold values are exceeded, logs the executed changes and allows rollbacks. The system may execute actions in response to threshold values being exceeded, and machine learning (Artificial Intelligence) actions can be carried for configuration, administration and/or orchestration types of activities. Such actions may be for example one of the following actions:
a. Install and add a NE to a cluster;
b. Drop a NE from a cluster;
c. Shut down interfaces (or the whole NCP) for reducing power consumption
d. Apply a configuration patch to a NE or to a Network Switch;
e. Apply a configuration patch to one or more controllers;
f. Add and remove communication tunnels;
g. Change communication tunnel BW;
h. Reroute to a Distributed Denial of Service (DDoS) scrubber;
i. Apply dynamically rules for an ACL;
j. Establish ACLs dynamically;
k. Determine routes and routing policies on a dynamic basis;
l. Apply and configure VRFs; and
m. Apply quality of service to communications being conveyed via network interfaces.

During operation, periodic calculations may be carried out using recently retrieved KPIs in order to identify trends in the network cloud operation. A machine learning algorithm may be used to generate hourly and/or daily and/or weekly trends, which may then be displayed visually to the network operator.

Furthermore, based on the calculated trends, predictions can be made and be then translated into relevant threshold values. The threshold values may be saved in a thresholds database which is comprised in this example within the cloud orchestrator, so that an event manager (part of the functionality carried out by the cloud orchestrator server) may trigger events upon exceeding these relevant threshold values.

In addition, a list of required or recommended actions may be generated based on the analysis of the collected information and the calculated predictions, and the managing entity of the cloud orchestrator (an administrator) may be used to determine whether a certain action should be executed, or whether to avoid preforming a certain action, or whether to automate a certain action, so that when applicable, that action will be carried out automatically.

Moreover, monitoring of failures may be carried out according to the following embodiment:
A) The node (a network element) as well as the generated KPIs associated with that node, are monitored at a pre-defined steady rate. However, once the system detects that a malfunction is about to occur, a detection window is opened, wherein this window is opened for a certain (e.g. pre-defined) time period, during which relevant KPIs are sampled at a rate higher than the steady rate applied before that window was opened, thereby enabling to detect the cause for the possible malfunction.
B) When monitoring the node (network element) as well as the generated KPIs associated with that node at a steady state, the monitoring system may apply a new-wave of streaming telemetry protocols (for example gRPC/gNMI), having a policy based KPI collection mechanism, where priority is assigned to each KPI that allows collecting values of more significant KPIs at higher rate, and such a KPI will receive a better QoS treatment in order to ensure that updates of the significant KPI values are properly received.
C) The monitoring system may also use KPI values collected in order to build a data-set for analyzing normal and abnormal KPI behaviors (in terms of statistical behavior, such as distribution, mean, standard deviation, bias, and the like.)

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A communication system configured to operate in a network cloud, the communication system comprising a plurality of physical network elements each comprising a respective agent and a server comprising a database storing a plurality of pre-defined actions and a plurality of thresholds values associated with key performance indicators (KPIs);
wherein said server is configured to operate as a cloud orchestrator and to receive from said plurality of physical network elements information that relates to key performance indicators (KPIs);
wherein upon determining that an action that relates to one or more specific physical network elements from among the plurality of physical network elements needs to be executed, wherein said determination is based on a) the information received from the plurality of physical network elements, and b) one or more threshold stored values and associated with said KPIs, an action selected from among said stored plurality of pre-defined actions is initiated, and required details associated with said selected pre-defined action are retrieved; and
wherein said cloud orchestrator is further configured to receive new KPIs from said one or more specific physical network elements and to verify that an improvement has occurred in their operation.

2. The communication system of claim 1, wherein said communication system further comprising a cloud controller configured to communicate with said plurality of the physical network elements' agents over a L2/L3 communication channel and to communicate in a two ways communication with said cloud orchestrator.

3. The communication system of claim 1, wherein said cloud orchestrator is further configured to trigger a configuration change at at least one of said plurality of physical network elements in response to determining that one or more threshold values have been exceeded.

4. The communication system of claim 1, wherein said cloud orchestrator is operative to configure a communication channel for conveying messages exchanged between physical network elements that are members of a cluster comprising said plurality of physical network elements, and/or between physical network elements that are members of said cluster and the cloud orchestrator.

5. The communication system of claim 4, wherein said messages comprise at least one type of messages being a member of a group that consists of: keepalive messages, configuration commands forwarded from said cloud orchestrator to modules installed at physical network elements, messages that are sent every pre-determined time interval to said cloud orchestrator and comprise information that relate to at least one of: current telemetry, statistics, events and KPIs.

6. The communication system of claim 1, wherein said cloud orchestrator is configured to ensure that a plurality of physical network elements operate as a single virtual routing entity.

7. The communication system of claim 1, wherein said cloud orchestrator is further configured to forward to said plurality of physical network elements the plurality of pre-defined actions and the plurality of KPI thresholds values for storage at said plurality of physical network elements, wherein the determination that an action needs to be executed is taken by one or more of said specific physical network elements, and wherein the action is selected from among said plurality of pre-defined actions stored at the one or more of said specific physical network elements and the required details associated with said selected action are retrieved from the one or more of said specific physical network elements' storage.

8. The communication system of claim 1, wherein the determination that an action needs to be executed is taken by said cloud orchestrator, and wherein the action is selected from among said plurality of pre-defined actions stored at the said cloud orchestrator database and the required details associated with said selected action are retrieved from the said cloud orchestrator storage.

9. The communication system of claim 1, wherein said cloud orchestrator is further configured to analyze traffic flows that are conveyed via said plurality of physical network elements and to identify traffic trends based on said traffic flows.

10. The communication system of claim 9, wherein said cloud orchestrator is further configured to determine based on the identified traffic trends one or more automatic actions and their associated threshold values, to be carried out in said communication system.

11. A method for use in a system operating in a network cloud, said system comprising a plurality of physical network elements each comprising a respective agent and a server operative as a cloud orchestrator and comprising a database, wherein the method comprises the steps of:
storing a plurality of pre-defined actions and a plurality of thresholds values associated with key performance indicators (KPIs);
receiving information that relates to key performance indicators (KPIs) from said plurality of physical network elements;
determining whether an action that relates to one or more specific physical network elements from among the plurality of physical network elements needs to be executed, wherein said determination is based on a) the information received from the plurality of physical network elements, and b) one or more threshold stored values;
upon determining that said action needs to be executed, retrieving details of the required action from among the plurality of pre-defined stored actions;
retrieving details associated with said selected pre-defined action;
carrying out the required action by the plurality of physical network elements; and
receiving new KPIs from said one or more specific physical network elements and verifying that an improvement has occurred in their operation.

12. The method of claim 11, further comprising the steps of determining whether one or more threshold values have been exceeded, and if in the affirmative, triggering a configuration change at at least one of said plurality of physical network elements.

13. The method of claim 11, further comprising a step of establishing a communication channel for conveying messages exchanged between physical network elements that are members of a cluster comprising said plurality of physical network elements, and/or between physical network elements that are members of said cluster and the cloud orchestrator.

14. The method of claim 13, wherein said messages comprise at least one type of messages being a member of a group that consists of: keepalive messages, configuration commands forwarded from said cloud orchestrator to modules installed at physical network elements, messages that are sent every pre-determined time interval to said cloud orchestrator and comprise information that relate to at least one of: current telemetry, statistics, events and KPIs.

15. The method of claim 11, further comprising a step of ensuring that a plurality of physical network elements operate as a single virtual routing entity.

16. The method of claim 11, further comprising a step of monitoring at least one physical network element and KPIs associated therewith at a pre-defined steady rate, and upon detecting that a malfunction is about to be associated with said physical network element, determining a time period during which relevant KPIs will be sampled at higher rate than the steady rate applied prior to making said determination.

17. The method of claim 11, further comprising the steps of:
storing the plurality of pre-defined actions and a plurality of thresholds values associated with key performance indicators (KPIs) at the cloud orchestrator database;
forwarding the plurality of pre-defined actions and a plurality of thresholds values associated with key performance indicators (KPIs) to said plurality of physical network elements and storing them thereat;
determining by one or more of said specific physical network elements whether said action needs to be executed;
upon determining that said action needs to be executed, retrieving details of the required action from among the plurality of pre-defined actions stored at the one or more of said specific physical network elements' storage.

18. The method of claim 11, further comprising the steps of:
storing the plurality of pre-defined actions and a plurality of thresholds values associated with key performance indicators (KPIs) at the cloud orchestrator database;
determining by said cloud orchestrator elements whether said action needs to be executed;
upon determining that said action needs to be executed, retrieving details of the required action from among said cloud orchestrator database.

19. A non-transitory computer readable medium storing a computer program for performing a set of instructions to be executed by one or more computer processors, the computer program is adapted to perform a method for use in a network cloud comprising a plurality of physical network elements and a server configured to operate as a cloud orchestrator, wherein said method comprising storing a plurality of pre-defined actions and a plurality of thresholds values associated with key performance indicators (KPIs); receiving information that relates to key performance indicators (KPIs) from said plurality of physical network elements; determining whether an action that relates to one or more specific physical network elements from among the plurality of physical network elements needs to be executed, wherein said determination is based on a) the information received from the plurality of physical network elements, and b) one or more threshold stored values; upon determining that said action needs to be executed, retrieving details of the required action from among the plurality of pre-defined stored actions; retrieving details associated with said selected pre-defined action; carrying out the required action by the plurality of physical network elements; and receiving new KPIs from said one or more specific physical network elements and verifying that an improvement has occurred in their operation.
